(19) United States
(12) Patent Application Publication
(10) Pub. No.: US 2008/0071610 A1
(43) Pub. Date: Mar. 20, 2008

(54) Techniques for tracking employee training

(75) Inventors: Harkirate Singh Dhillon, Hillsborough, NJ (US); Daniel Kogan, Manalapen, NJ (US); Michael Broderson, Littsle Egg Harbor, NJ (US)

Correspondence Address: GORDON E NELSON;PATENT ATTORNEY, PC, 57 CENTRAL ST, PO BOX 782, ROWLEY, MA, 01969, US

(73) Assignee: Sparta Systems, Inc.

(21) Appl. No.: 11/851,777

(22) Filed: Sep. 7, 2007

Related U.S. Application Data
(60) Provisional application No. 60/825,024, filed on Sep. 8, 2006.

(51) Int. Cl. G06Q 10/00

(52) U.S. Cl. 705/11

(57) ABSTRACT

A process control system has a server which has access to a database system and executes program code for the process control system. The database system includes a table of process records which indicate a configuration of a training process. An administrator configures process records for the training process and how the training process is applied to employees. The training process includes training requirements and a training schedule. When a portion of the program code executes, it automatically creates training records for each eligible employee for each training requirement at times and intervals specified by the training schedule. The process records includes employee records for tracking information about the employees, template records for defining fields to be copied to the training records, change control records for tracking changes to the training requirements; and training records for tracking progress of the employees for the training requirements.

### CROSS-REFERENCE TO RELATED APPLICATIONS

This application claims priority to co-pending U.S. provisional patent application entitled “Techniques for Tracking Employee Training”, Ser. No. 60/825,024, filed on Sep. 8, 2006.

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

1. Field of the Invention

This invention relates to the field of process control, and more particularly to techniques for using a database system to implement a table-driven training process control system.

2. Description of Related Art

To date, the use of computers in managing a training process has typically been limited to employing a calendar-date system that reminds the operator when a training session has been scheduled. Conventionally, they rely on manual input and require human interaction to schedule and track training events and their recurrence and to make decision and take action accordingly. However, some training curriculums are complex, with stringent tracking and reporting requirements. The conventional approach is thus burdensome for the management of complex training processes of employees.

Although computer programs can always be developed to schedule and track conditions during a training process and to particular sequences of conditions, such programs are of limited use, as they require code changes whenever new conditions and new requirements arise. Moreover, program code is by its nature general, and user-made modifications to a process control system's code can have consequences for the system that go far beyond what the user intended.

Accordingly, there exists a need for a process control system for tracking employee training that eliminate the dependency on human operators and that manages the training process in a safe and user-friendly manner.

### BRIEF SUMMARY OF THE INVENTION

A process control system has a server which has access to a database system and executes program code for the process control system. The database system includes a table of process records which indicates a configuration of a training process. An administrator configures process records for the training process and configures how the training process is applied to employees. The training process includes training requirements and a training schedule. When a portion of the program code executes, it automatically creates training records for each eligible employee for each training requirement at times and intervals specified by the training schedule. The process records includes employee records for tracking information about the employees, template records for defining fields to be copied to the training records, change control records for tracking changes in training requirements; and training records for tracking progress of the employees for the training requirements.

In one aspect of the invention, the training process is configured through a training manager module, which is a collection of graphical user interfaces. The training manager module includes five areas: configuration area, requirements area, curriculum area, change control area, and force training area. The configuration area allows the configuration of training record types, employee active states, and training constants. The requirements area allows the configuration of completed states for training, training workflows, training schedules, and training requirements. The curriculum area allows the configuration of training curriculums, employee title fields, and curriculum mapping. The change control area allows the configuration of change control states which trigger training, change control field dependencies, and change control relations. The force training area allows a training manager administrator to force retraining on a requirement for a user or group of users.

Once configured, the process control code continually runs the training process and handles the automatic creation of training records by evaluating the configuration and schedules training for employees as needed.

### BRIEF DESCRIPTION OF THE SEVERAL VIEWS OF THE DRAWINGS

FIG. 1 shows an overview of an embodiment of an automated process control system.

FIG. 2 shows the records in the PR table that represent training processes being controlled by the system.

FIG. 3 shows the areas of a Training Manager Module, through which the configuration of a training process is accessed.

FIG. 4 illustrates the set up of the training process in the configuration area of the Training Manager module.

FIG. 5 illustrates the set up of the training process in the Requirements area of the Training Manager module.

FIG. 6 illustrates the set up of a training process in the Curriculum area of the Training Manager module.

FIG. 7 illustrates the set up in the Change Control area of the Training Manager module.

FIG. 8 illustrates the set up of the training process in the Force Training area of the Training Manager module.

FIGS. 9-11 illustrate entity-relationship diagrams showing relationships between database tables of the system.

FIGS. 12A-16B illustrate GUI's for the configuration of the training process.

FIGS. 17-18 are flowcharts illustrating the creation and tracking of Training Records for employees by the process control code.

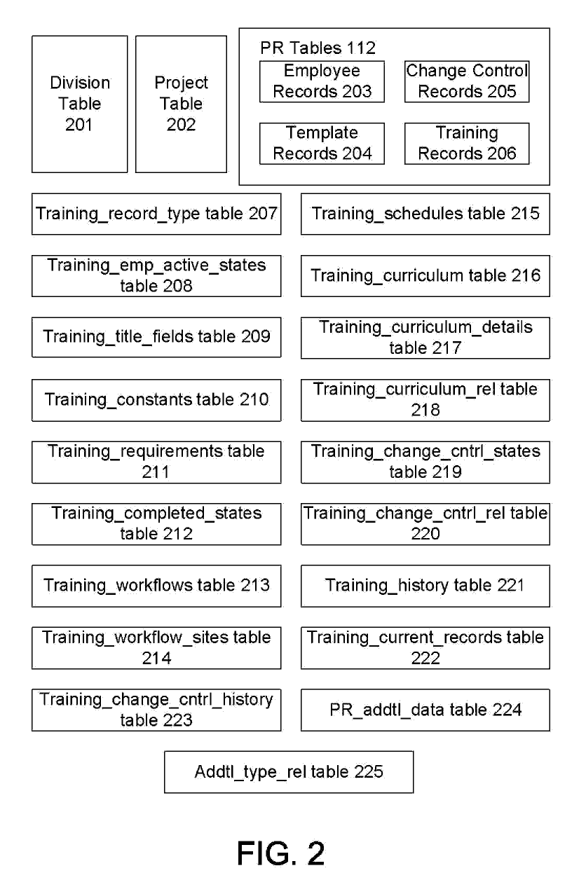

Reference numbers in the drawing have three or more digits: the two right-hand digits are reference numbers in the drawing indicated by the remaining digits. Thus, an item with the reference number 203 first appears as item 203 in FIG. 2.

### DETAILED DESCRIPTION OF THE INVENTION

The invention uses a process control system that has a server which has access to a database system and executes program code for the process control system. The database system includes a table of process records. The process records include process records which specify a training process. An administrator configures process records for the training process and configures how the training process is applied to employees. The training process includes training requirements and a training schedule. A portion of the program code automatically creates training records for each training requirement for each eligible employee at times and intervals specified by the training schedule.

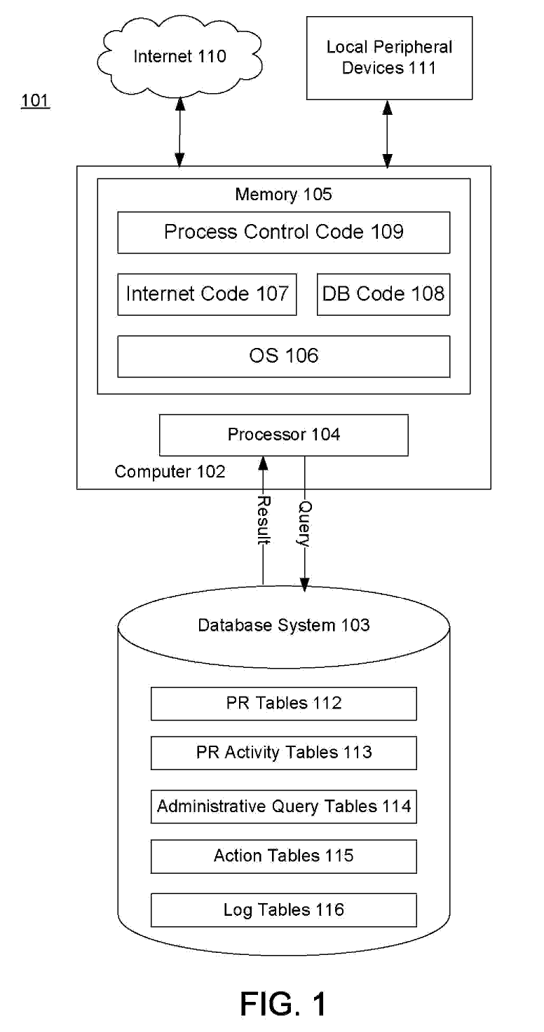

FIG. 1 shows an overview of an embodiment of an automated process control system 101 which has been modified to embody the invention. The general process control system 101 is described in U.S. Pat. No. 7,216,132, assigned to the same assignee as the present application. U.S. Pat. No. 7,216,132 is hereby incorporated herein in its entirety. New process record types and tables are added to the general process control system 101 to implement the system 101 for use in managing, tracking, and maintaining clear, accurate, and compliant training records for employees.

System 101 is implemented using a standard computer 102 that is connected to a standard database (DB) system 103. In an exemplary embodiment, the DB system 103 is a relational database system made by Oracle Corporation™, of Redwood City, Calif. Standard computer 102 has a processor 104 which is connected to Internet 110 and to local peripheral devices 111 as well as to DB system 103. Processor 104 has a memory 105 (understood to include both physical and virtual memory) which includes code executed by processor 104. Such code includes operating system code 106, Internet code 107, for performing functions such as email and interacting with Web pages according to the HTTP protocol, database (DB) code 108, which is part of and controls the operation of DB system 103, and process control code 109, which is application code that implements the process control system. Process control code 109 uses components of the operating system 106, Internet code 107, and DB code 108 to interact with Internet 110, local peripheral devices 111, and DB system 103.

Process control system 101 works by making records of processes that are being controlled in a table in DB system 103. Predefined administrative queries that are stored in a table DB system 103 can be used to query the table and perform activities that are predefined for the query on the result set of records returned by the query.

DB system 103 includes PR (process record) tables 112, which are the tables that contain the records for the processes, PR activity table 113, containing records that define and log activities, action tables 115, whose records define the actions that make up an activity, and administrative query tables 114, which define the administrative queries that system 101 may execute on the PR tables 112. Log tables 116 keep track of the state of a process with regard to a query and also chart trends in the processes being controlled.

The use of tables in DB system 103 to determine the behavior of the process control system makes system 101 highly configurable, but limits the configurability so that it can be safely done by non-technical users of system 101. All of the tools provided by DB system 103 for configuring entries in its tables are available to configure the entries in the tables of DB system 103, as are the user interfaces which DB system 103 provides for those tools. These user interfaces strongly limit the amount of damage that can be done to the tables, and thereby to system 101, by an unskilled user. System 101 is made still more safe and easy to use by a graphical user interface that is implemented on top of the user interfaces provided by DB system 103. Using the graphical user interface, the user of the system 101 can define PR records as required for the occurrences that are important to the processes, can define his or her own PR activities in PR activity tables 113, can define his or her own queries in administrative query tables 114, including the activities to be performed in response to the queries, and can define an activity's actions in detail in action tables 115.

Both configuration and query execution are done by process control code 109, which adds records to and deletes them from the tables and configures the individual records. System 101 can run on a single computer 102, which functions as a server for the system, or alternatively it can run concurrently on a plurality of servers for load balancing purposes.

The relationships between records in the tables are used to organize the data in the database. As shown in FIG. 2, in system 101, the records representing training processes that are being controlled by system 101 are in PR table 112. PR table 112 contains all process records in the database. The data fields in this table describe a training process. In system 101, the user can group the records in PR tables 112 by project, and can group projects by division. The subdivision is done by means of Project table 202 and Division table 201. Each record in PR table 112 has a project_id field whose value is an identifier for a record in the Project table 202, and that record identifies the project that the record in PR table 112 belongs to. Each record in Project table 202 has a division_id field whose value identifies a record in Division table 201, and that record identifies the division that the record in Project table 202 belongs to.

Four new process record types are added to the system 101 to configure and implement training processes: Employee Records 203, Template Records 204, Change Control Records 205, and Training Records 206. Employee Records 203 are used to track information about an employee. Template Records 204 define fields that will be copied to Training Records 206 created for each training requirement configured for the training process. Training requirements define the training template, workflow, schedule, and how a Training Record 206 will be linked to the associated employee's Employee Record 203. Change Control Records 205 are used to track retraining per training requirement per employee due to changes in the training requirements. Training Records 206 are used to track an individual employee's progress for a particular training requirement. One Training Record 206 is created for each training requirement for each employee eligible for the training requirement at a time and interval specified in a training schedule. These records are stored as PRs in the PR table 112.

All PR records, including an Employee Record 203, a Template Record 204, a Change Control Record 205, or a Training Record 206, contain system fields that look like this:

| | |
|---|---|
| PR( | |
| id | NUMBER(12) |
| ref_number | VARCHAR2(320) |
| name | VARCHAR2(480) |
| parent_id | NUMBER(12) |
| project_id | NUMBER(12) |
| project_parent_id | NUMBER(12) |
| module_id | NUMBER(12) |
| version_id | NUMBER(12) |
| fix_version_id | NUMBER(12) |
| duplicate_id | NUMBER(12) |
| category_type | NUMBER(12) |
| priority_type | NUMBER(12) |
| severity_type | NUMBER(12) |
| more_info_type | NUMBER(12) |
| required_time | NUMBER(10,2) |
| time_unit_type | NUMBER(6) |
| required_cost | NUMBER(12,2) |
| is_billlable | NUMBER(2) |
| status_type | NUMBER(6) |
| opened_type | NUMBER(12) |
| originator_rel_id | NUMBER(12) |
| originator_dept_id | NUMBER(12) |
| entity_id | NUMBER(12) |
| customer_rel_id | NUMBER(12) |
| customer_name | VARCHAR2(160) |
| responsible_rel_id | NUMBER(12) |
| responsible_name | VARCHAR2(160) |
| date_opened | DATE |
| date_to_close | DATE |
| date_closed | DATE |
| date_last_activity | DATE |
| date_current_state | DATE |
| is_closed | NUMBER(1) |
| date_created | DATE |
| date_updated | DATE |
| created_by_rel_id | NUMBER(12) |
| updated_by_rel_id | NUMBER(12) |
| es_applied | NUMBER(1) |
| desk_is_done | NUMBER(2) |
| is_pending | NUMBER(2) |
| tw_sync_done | NUMBER(2) |
| root_parent_id | NUMBER(12) |
| curr-state-node_id | NUMBER(12) |
| user_group_id | NUMBER(12) |
| date_start | DATE |
| frozen_by_rel_id | NUMBER(12) |
| date_frozen | DATE |
| is_frozen | NUMBER(2) |
| source_pr_id | NUMBER(12) |
| s_external_id | VARCHAR2(254) |
| ) | |

The essential fields of the PR record are:

(a) id: a unique ID for the record in this table;

(b) project_id: the ID of the record in the Project table 202 for the project that the project represented by the given PR record belongs to;

(c) date_created: the exact date/time that a given PR is created, i.e., that the given row into the PR has been inserted;

(d) date_opened: the date/time that the associated process, event etc. should be associated with, e.g., the date/time that a customer called with a request;

(e) parent_id: the ID of a parent PR, if any;

(f) status_type: current status of the PR, e.g, “Opened”, and “Work in Progress”;

(g) is_closed: a Boolean value indicating whether a PR is closed or is still active;

(h) date_due: the date due for completing a process, i.e., date due for closing a PR;

(i) created_by_rel_id: a specific ID of a person who created the given PR record in the database;

(j) originator_rel_id: a specific ID of a person who is considered the originator or the “sponsor” of the given PR.

(k) responsible_rel_id: a person that is assigned to the given PR, referred to as the Assigned To;

(l) updated_by_rel_id: a specific ID of a person that the given PR was last updated by;

(m) date_current_state: a date/time that the status of the given PR was last changed;

(n) date_closed: a date/time that the given PR was closed, if at all;

(o) date_last_activity: a date/time that a PR Activity was last performed for the given PR;

(p) customer_rel_id: a specific ID of a contact associated with the given PR;

(q) entity_id: a specific ID of a company associated with the given PR, and

(r) date_updated: a date and time that a given record in the PR table was last updated.

A PR record may additionally contained user-defined fields. User defined fields are fields that are defined by Administrator users via a graphical user interface provided by the screens in the system's Administrator module. These screens allow an Administrator user to define an unlimited number of fields of any type supported by the system. The fields are given a unique name and field type. Some of the supported field types include Person fields that represent a person, Selection fields that allow users to select from a list of options, Training Requirement Fields that are selection fields whose values represent training requirements, and String Fields for string values. In the case of the PR records used to specify training, the definitions of the relevant user-defined fields are contained in a PR_addtl_data table 224.

Specific user-defined fields in Employee Records 203 include: (a) Employee Record Person field: a value used to determine which person the Employee Record represents. This field can be a Person field from the PR table schema or a user-defined person field from the PR_addtl_data table 224. A Person field can be any field in the PR table schema that is defined as representing a person.

(b) Title fields: these values are used to determine which title(s) an employee has. From the titles, the corresponding curriculum, and training requirements within the curriculums, can be determined. Title fields can only be user-defined selection or multi selection fields stored in the PR_addtl_data table 224.

No specific associated fields are required for Template Records 204. Template Records 204 do not require a specific field to be set because the Template Record 204 is used as a placeholder for generic information. When a Training Record 206 is created, the Template Record's fields are copied over to the Training Record 206. Hence, this record type usually only stores general information related to the training requirement. A user of the system 101 can configure informational fields, such as File Attachments related to a specific item to be trained. These informational fields pertain to items that are not used to drive the creation of Training Records 206 but which the user may wish to track for other purposes.

Specific user-defined fields in Change Control Records 205 include:

(a) Training Requirement fields: when a Change Control Record reaches a change control state in a training workflow, the creation of a Training Record 206 is automatically triggered. The system 101 determines which training requirements are relevant to the Change Control Record 205 by evaluating all the single and multi training requirement fields in the Change Control Record 205. All the selected values are considered training requirements that need retraining. Training Records 206 are created for employees with curriculums that include any of these training requirements according to a training schedule.

Specific user-defined and system fields in Training Records 206 include:

(a) Training Record Requirement field: this field is a user-defined training requirement field which is always stored in the PR addtl data table 224. When a Training Record 206 is created, the value of the field is set automatically to the associated training requirement.

(b) Link to Employee Record field: the link of a Training Record 206 to an Employee Record 203 can be a parent child relationship or via a user-defined Reference Record field. If the link is a parent/child one, then the parent_id of the Training Record 206 is set to the value of the employee_id, i.e., the record ID of the Employee Record 203. If the link is via a Reference Record, then the value of the employee_id is set to the user-defined Reference Record. All Reference Record fields are stored in the PR_addtl_data table 224.

(c) Assigned To field: this field is a system field (responsible_name) that indicates who is responsible for the Employee Record 203 to which the Training Record 206 applies. When a Training Record 206 is created, the Assigned To field is set to the value of the Employee Record Person field of the Employee Record 203.

Other tables used to configure and implement the training process include:

(a) Training_record_type table 207: this table is used to store projects for a training record type. A record in the Training_record_type table 207 looks like this:

| | |
|---|---|
| Training_record_type | |
| ( | |
| ID | NUMBER(12), |
| RECORD_TYPE | NUMBER(12), |
| PROJECT_ID | NUMBER(12) |
| DATE_UPDATED | DATE |
| ) | |

Values for the record_type field include Employee, Template, and Change Control. The project_id field is the record ID of the project in the Project table 202 for the project that the training record type will be created in. The project for the Training record type is defined in the configuration of a training workflow, as described further below. Defined in the process control code 109 are queries for accessing and reading in values in the Training_record_type table 207 during execution. These values apply to all Employee 203, Template 204, and Change Control 205 Records in the system 101.

(b) Training_emp_active_states table 208: this table is used to store the states where employees are considered “Active”. A record in the Training_emp_active states table 208 looks like this:

| Training_emp_active_states | |
|---|---|
| ( | |
| ID | NUMBER(12), |
| PR_STATUS_TYPE | NUMBER(12), |
| DATE_UPDATED | DATE |
| ) | |

The value for the state is stored in the pr_status_type field. System and user-defined states are stored in a pr_status_type table of the system 101, with each potential state having a record in the table. The states in which employees are considered “active” are defined by the records in the Training_emp_active_states table 208. Employee's with Employee Records 203 in an active state may be eligible for training. Defined in the process control code 109 are queries for accessing and reading in values in the Training_emp_active_states table 208.

(c) Training_title_fields table 209: this table is used to determine which selection and multi-selection fields in the system 101 are used to determine an employee's job title. A record in the Training_title_fields table 209 looks like this:

| | |
|---|---|
| Training_title_fields | |
| ( | |
| ID | NUMBER(12), |
| DATA_FIELD_ID | NUMBER(12), |
| DATE_UPDATED | DATE |
| ) | |

The data_field_id is the ID for the field in an Employee Record 203 that is considered to be employee's job title fields. The title field value is used to determine whether the employee is eligible for a training requirement. A training requirement is configured with one or more title fields. Employees with certain job titles as specified in these selected title fields are determined to be eligible for the training requirement.

(d) Training_constants table 210: this table is used to store various global settings for the training process. A record is created in the Training_constants table 210 for each constant, and each record looks like this:

| | |
|---|---|
| Training_constants | |
| ( | |
| ID | NUMBER(12), |
| NAME | VARCHAR2(254), |
| N_VALUE | NUMBER(12), |
| DATE_UPDATED | DATE |
| ) | |

The name field stores the name of the constant, and the n_value field stores the value of the constant. The Training_constants table 210 is accessed by the process control code 109 at the beginning of a processing cycle and cached for the duration of the cycle.

(e) Training_requirements table 211: this table is used to store the training requirements and their association with training workflows and training schedules. A record is created in the Training_requirements table 211 for each training requirement, and each record looks like this:

| | |
|---|---|
| Training_requirements | |
| ( | |
| ID | NUMBER(12), |
| NAME | VARCHAR2(254), |
| TEMPLATE_PR_ID | NUMBER(12), |
| TRAINING_WORKFLOW_ID | NUMBER(12), |
| TRAINING_SCHEDULE_ID | NUMBER(12), |
| IS_CHILD_OF_EMPLOYEE | NUMBER(2), |
| REF_RECORD_FIELD_ID | NUMBER(12), |
| DATE_UPDATED | DATE |
| ) | |

The name field stores the name of the training requirement. The template rid is the record ID of the Template Record 204 to be used in creating the Training Record 206. The training_workflow_id is the record ID of the training workflow associated with the training requirement, and the training_schedule_id is the record ID of the training schedule associated with the training requirement. The is_child_of_employee and ref_record_field_id fields are used in linking Training Records 206 created for the training requirement to Employee Records 203.

(f) Training_completed_states table 212: this table is used to store the states where the Training Record 206 is considered ‘Completed’. A record is created in the Training_completed_states table 212 for each state, and each record looks like this.

| Training_completed_states | |
|---|---|
| ( | |
| ID | NUMBER(12), |
| PR_STATUS_TYPE | NUMBER(12), |
| DATE_UPDATED | DATE |
| ) | |

The value of the state is stored in the pr_status_type field. The potential states are stored in the PR_status_type table of the system 101. The states in which a Training Record 206 is considered “completed” is defined by the records in the Training_completed_states table 212. The Training_completed_states table 212 is accessed by the process control code 109 at the beginning of a processing cycle and cached for the duration of the cycle.

(g) Training_workflows table 213: this table is used to store the information for workflows used by the training process when creating Training Records 206. A record is created in the Training_workflows table 213 for each workflow, and each record looks like this:

| | |
|---|---|
| Training_workflows | |
| ( | |
| ID | NUMBER(12), |
| NAME | VARCHAR2(254), |
| SITE_SPECIFIC | NUMBER(2), |
| PROJECT_ID | NUMBER(12), |
| DATE_UPDATED | DATE |
| ) | |

The name field stores the name of the workflow. The site_specific field indicates whether the workflow is configured regardless of an employee's site/division or relative to an employee's site/division. The project id is the record ID of a project in the Project table 202, in which Training Records are created when created according to the workflow. When the workflow is site specific a fallback project is stored in the project_id column of the Training_workflows table 213. When the workflow is not site specific, the project_id column is used to store the project used for every training requirements that are associated with this workflow.

(h) Training_workflow_sites table 214: this table is used to store the site specific details for a given training workflow, if the workflow is configured relative to an employee's site/division. A record in the training_workflow_sites table 214 looks like this:

| | |
|---|---|
| Training_workflow_sites | |
| ( | |
| ID | NUMBER(12), |
| TRAINING_WORKFLOW_ID | NUMBER(12), |
| PROJECT_ID | NUMBER(12), |
| DATE_UPDATED | DATE |
| ) | |

The training_workflow_id is the ID of the record in the Training_workflows table 213 to which the site information pertains. The project_id is the record ID of a project in the Project able 202, in which Training Records 206 are created when created according to the workflow. If a particular site has no definition, the Training Records 206 that are created in this site uses the fallback project stored in the project_id column of the record in the Training_workflows table 213.

(i) Training_schedules table 215: this table is used to store the information for training schedules used by the training process when creating Training Records 206. A record is created in the Training_schedules table 215 for each schedule, and each record looks like this:

| | |
|---|---|
| Training_schedules | |
| ( | |
| ID | NUMBER(12), |
| NAME | VARCHAR2(254), |
| ITERATION | NUMBER(2), |
| TIME_INTERVAL | NUMBER(2), |
| LAST_TIME_COMPLETED | NUMBER(2), |
| SOURCE | NUMBER(2), |
| DATA_FIELD_ID | NUMBER(12), |
| CREATE_INITIAL_TRAINING_RECORD | NUMBER(2), |
| NUM_DAYS_CREATE_BEFORE | NUMBER(12), |
| DATE_UPDATED | DATE |
| ) | |

The name field stores the name of the schedule. The iteration and time_interval fields are used to determine the times when the Training Records 206 should be created. The last_time_completed and source fields are used to indicate when the Training Records 206 should be created relative to another time or event. The create_initial_training_record field is set if a Training Record 206 for an employee is to be created immediately regardless of the schedule. The num_days_create_before field is used to indicate how many days before the training is due should the Training Record 206 be created.

(j) Training_curriculums table 216: this table is used to store the training curriculums. Training curriculums are used to group training requirements. A record in the Training_curriculums table 216 looks like this:

| | |
|---|---|
| Training_curriculums | |
| ( | |
| ID | NUMBER(12), |
| NAME | VARCHAR2(254), |
| DATE_UPDATED | DATE |
| ) | |

The name field stores the name of the curriculum.

(k) Training_curriculum_details table 217: this table is used to store the training requirements within a given training curriculum. A record is created in the Training_curriculum_details table 217 for each training requirement in the curriculum, and each record looks like this:

| | |
|---|---|
| Training_curriculum_details | |
| ( | |
| ID | NUMBER(12), |
| TRAINING_CURRICULUM_ID | NUMBER(12), |
| TRAINING_REQUIREMENT_ID | NUMBER(12), |
| DATE_UPDATED | DATE |
| ) | |

The training_curriculum_id field is the record ID of the curriculum in the Training_curriculum table 216. The training_requirement_id field is the record ID of the training requirement in the Training_requirements table 211 to be added to the curriculum.

(l) Training_curriculum_rel table 218: This table is used to store mappings of training curriculums to parent selection field values (i.e., employee's job title). A record in the Training_curriculum_rel table 218 looks like this:

| | |
|---|---|
| Training_curriculum_rel | |
| ( | |
| ID | NUMBER(12), |
| PREVIOUS_REL_ID | NUMBER(12), |
| PARENT_FIELD_ID | NUMBER(12), |
| PARENT_N_VALUE_ID | NUMBER(12), |
| TRAINING_CURRICULUM_ID | NUMBER(12), |
| DATE_UPDATED | DATE |
| ) | |

The parent_field_id is the ID of the field in the Employee Record 203 that is used to determine the employee's job title, and the parent_n_value_id is the value of this field. The training_curriculum_id is the record ID of the curriculum in the Training_curriculum table 216. All employees that have the parent selection field value for the title field will be assigned this particular curriculum. If an employee has multiple curriculums that contain the same training requirements, only one instance of the training requirement will be applicable so that the same Training Records 206 are not created multiple times.

The previous_rel_id is the ID of the branch in a hierarchy of training title fields. This column identifies a particular branch of a dependent hierarchy in an Addtl_type_rel table 225. The Addtl_type_rel table 225 stores all the different hierarchies defined in the system. For example, the training curriculum is mapped to an employee job title in Building A, Floor 1, while the training curriculum is mapped to the employee job title in Building B, Floor 1 and 2. Here, previous_rel_id field would indicate whether the branch in the hierarchy is Building A or Building B. If for Building A, then the training curriculum is only mapped to employees with the job title on Floor 1. If for Building B, then the training curriculum is mapped to employees with the job title on Floors 1 and 2.

(m) Training_change_control_states table 219: This table is used to store the states that trigger the creation of a Training Record 206 when a Change Control record 205 enters the given state. A record is created in the Training_change_control_states table 219 for each state, and each record looks like this:

| | |
|---|---|
| Training_change_control_states | |
| ( | |
| ID | NUMBER(12), |
| PR_STATUS_TYPE | NUMBER(12), |
| DATE_UPDATED | DATE |
| ) | |

The value of the state is stored in the pr_status_type field. Potential states are stored in the PR_status_type table of system 101. The change control states are defined by the records in the Training change control states table 219. Queries for accessing the Training_change_control_states table 219 are defined in the process control code 109.

(n) Training_change_control_rel table 220: This table is used to store mappings of training requirements to parent selection field values. A record in the Training_change_control_rel table 220 looks like this:

| | |
|---|---|
| Training_change_control_rel | |
| ( | |
| ID | NUMBER(12), |
| PREVIOUS_REL_ID | NUMBER(12), |
| PARENT_FIELD_ID | NUMBER(12), |
| PARENT_N_VALUE_ID | NUMBER(12), |
| CHILD_FIELD_ID | NUMBER(12), |
| CHILD_N_VALUE_ID | NUMBER(12), |
| DATE_UPDATED | DATE |
| ) | |

The parent_field_id indicates the single selection data field that is to be a parent record, and the child_field_id indicates the training requirement that is to be a child record. The parent_n_value_id and the child_n_value id fields are the values of the parent and child records, respectively. The parent record allows the limiting of available training requirements for a given Change Control Record 205. The training requirements are filtered by the selection, such as “department”. For example, the selection for the parent field can be “Finance” as the department value. Then, only finance specific training requirements would be available for selection for the Change Control Record 205.

(o) Training_history table 221: This table is used to store a row for each employee per training requirement per training record. A record in the Training_history table 221 looks like this:

| | |
|---|---|
| Training_history | |
| ( | |
| EMPLOYEE_ID | NUMBER(12), |
| TRAINING_REQUIREMENT_ID | NUMBER(12), |
| TRAINING_RECORD_ID | NUMBER(12), |
| DATE_CREATED | DATE |
| TARGET_DATE_DUE | DATE |
| DATE_UPDATED | DATE |
| ) | |

The employee_id is the record ID of the Employee Record 203 associated with the employee for which the Training Record was created. The training_requirement_id is the record ID of the record in the Training_requirements table 211 for which the Training Record was created. The training_record_id is the record ID of the Training Record 206 that was created. Queries for accessing the Training_history table 221 are defined in the process control code 109.

(p) Training current_records table 222 This table is used to store the current Training Record id for a given employee and a given training requirements. A record in the Training_current_records table 222 looks like this:

| | |
|---|---|
| Training_current_records | |
| ( | |
| ID | NUMBER(12), |
| EMPLOYEE_ID | NUMBER(12), |
| TRAINING_REQUIREMENT_ID | NUMBER(12), |
| TRAINING_RECORD_ID | NUMBER(12), |
| IS_COMPLETE | NUMBER(12), |
| IS_CANCELLED | NUMBER(12), |
| DATE_LAST_COMPLETE | DATE, |
| DATE_LAST_CANCELLED | DATE, |
| DATE_CREATED | DATE |
| TARGET_DATE_DUE | DATE |
| DATE_UPDATED | DATE |
| ) | |

The employee_id is the record ID of the Employee Record 203 for the given employee. The training_requirement_id is the record ID of the record in the Training_requirements table 211 for the given training requirement. The training_record_id is the record ID of the current Training Record 206. The is_complete, is_cancelled, date_last_complete, and date_last_cancelled fields indicate whether and when the given training requirement was completed or cancelled for the given employee. The target_date_due field indicate the target date for completion by the given employee for the given training requirement. Queries for accessing the Training_current_records table 222 are defined in the process control code 109.

The Training_current_records table 222 contains a subset of records in the Training_history table 221. Queries targeted for Training Records 206 recently created can be run against the Training_current_records table 222 rather than the Training_history table 221 in order to realize greater efficiency.

(q) Training_change_cntrl_history table 223: This table is used to store a row for each employee for each Training Record 206 created for a given training requirement as a result of a given Change Control Record 205. A record in the Training_change_cntrl_history table 223 looks like this:

| | |
|---|---|
| Training_change_cntrl_history | |
| ( | |
| EMPLOYEE_ID | NUMBER(12), |
| TRAINING_REQUIREMENT_ID | NUMBER(12), |
| CHANGE_CONTROL_RECORD_ID | NUMBER(12), |
| DATE_CREATED | DATE |
| TARGET_DATE_DUE | DATE |
| DATE_UPDATED | DATE |
| ) | |

The employee_id is the record ID of the Employee Record 203 associated with the employee for which the Training Record was created due to Change Control settings. The training_requirement_id is the record ID of the record in the Training_requirements table 211 for which the Training Record was created due to Change Control settings. The change_control_record_id is the record ID of the Change Control Record 205 according to which the Training Record 206 was created.

(r) PR_addtl_data table 224: This table is used to store user defined field values. The columns are generic and are reused to store the values of different field types. A record in the PR_addtl_data table 224 looks like this:

| | |
|---|---|
| PR_addtl_data | |
| ( | |
| ID | NUMBER(12) |
| DATA_FIELD_ID | NUMBER(12) |
| PR_ID | NUMBER(12) |
| S_VALUE | VARCHAR2(1016) |
| LS_VALUE | BLOB |
| N_VALUE | NUMBER |
| DEC_VALUE | NUMBER(10,2) |
| DATE_VALUE | DATE |
| DATE_TIME_VALUE | DATE |
| SEQ_NO | NUMBER(4) |
| DATE_UPDATED | DATE |
| FILE_TYPE | VARCHAR2(40) |
| EXTERNAL_DATA_ID | NUMBER(12) |
| ) | |

As indicated by the PR_ID and DATA_FIELD_ID fields, there is a PR_addtl_data record for each PR record and data field combination in the training PR records. The record's value has one of the types indicated above. In the case of values having the N_value type, the values are row identifiers to rows in other tables. Examples of values having the N_value type are values for training requirement fields, person field, and selection fields

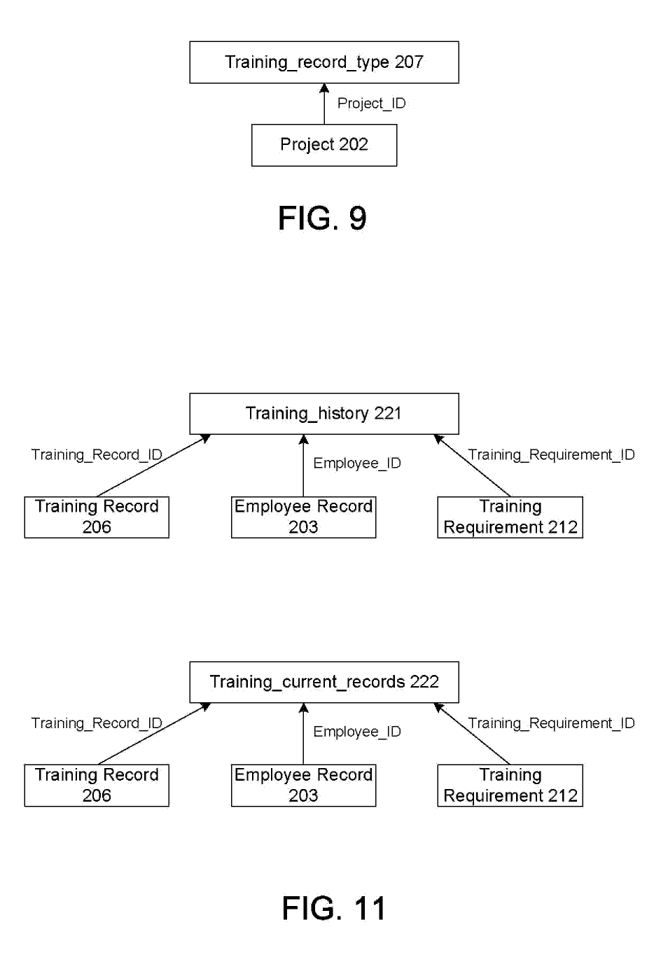

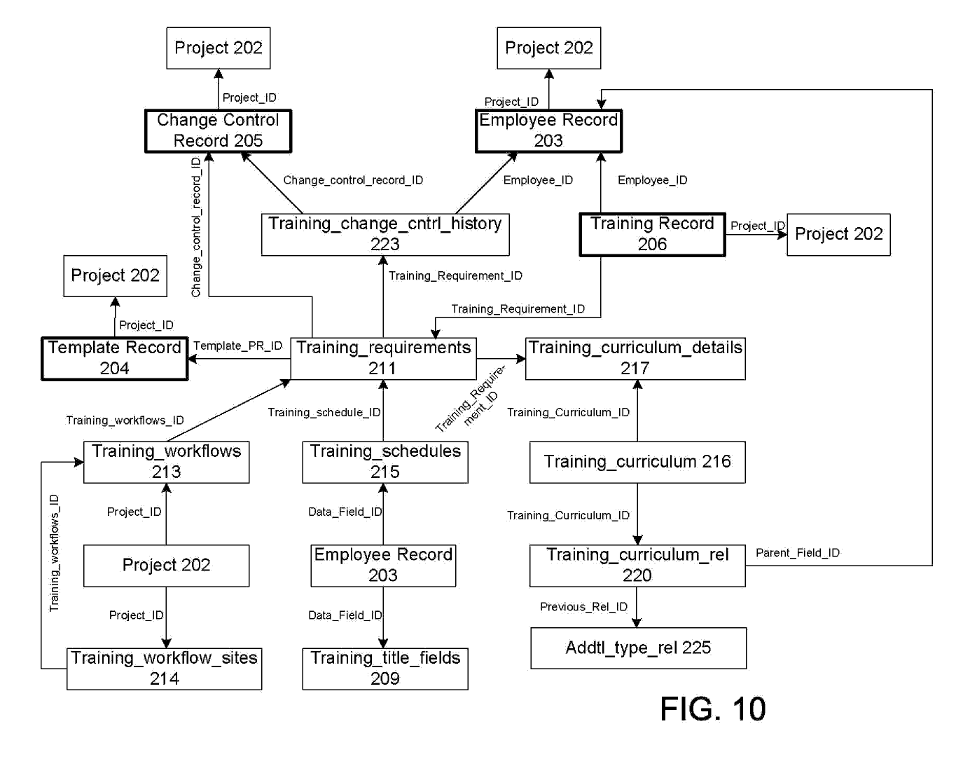

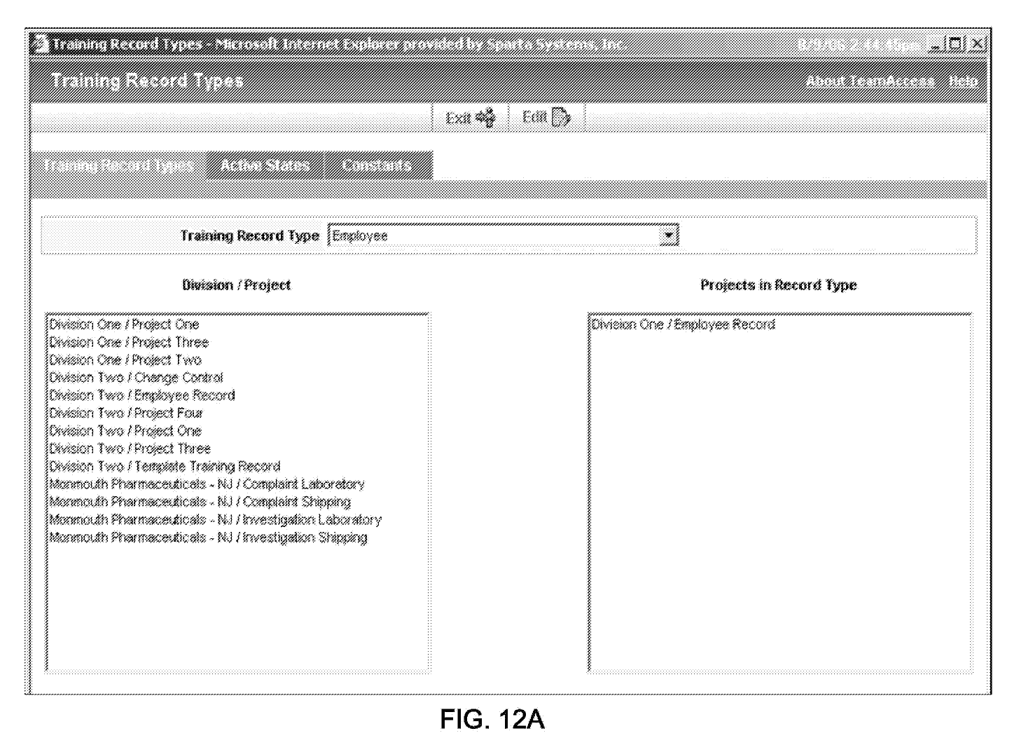

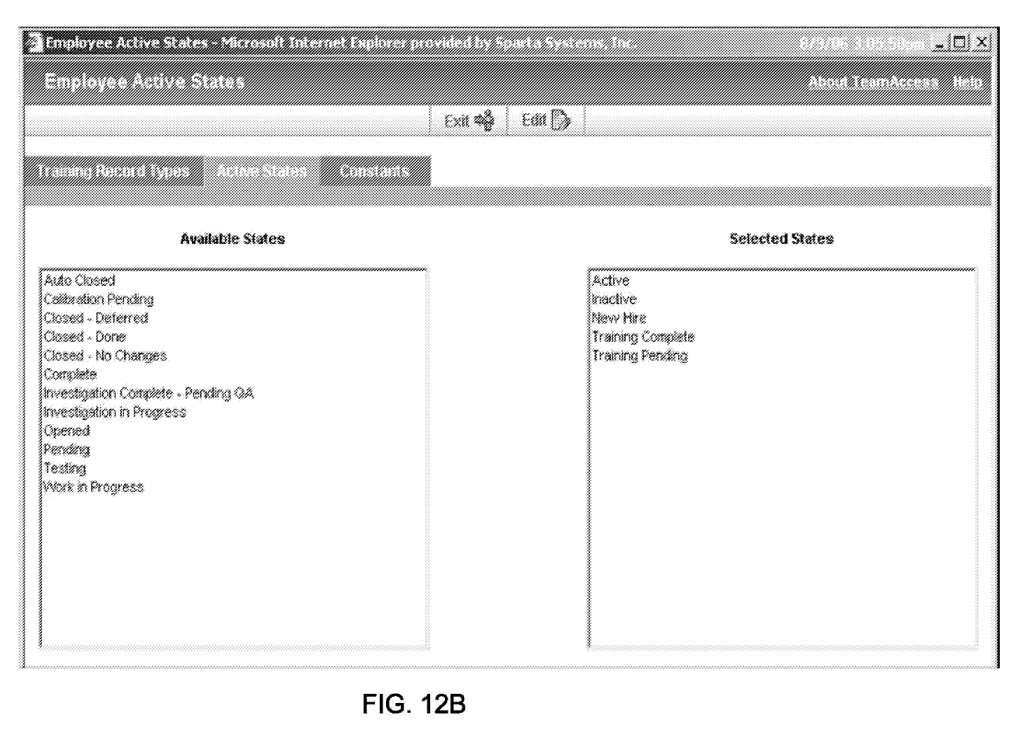

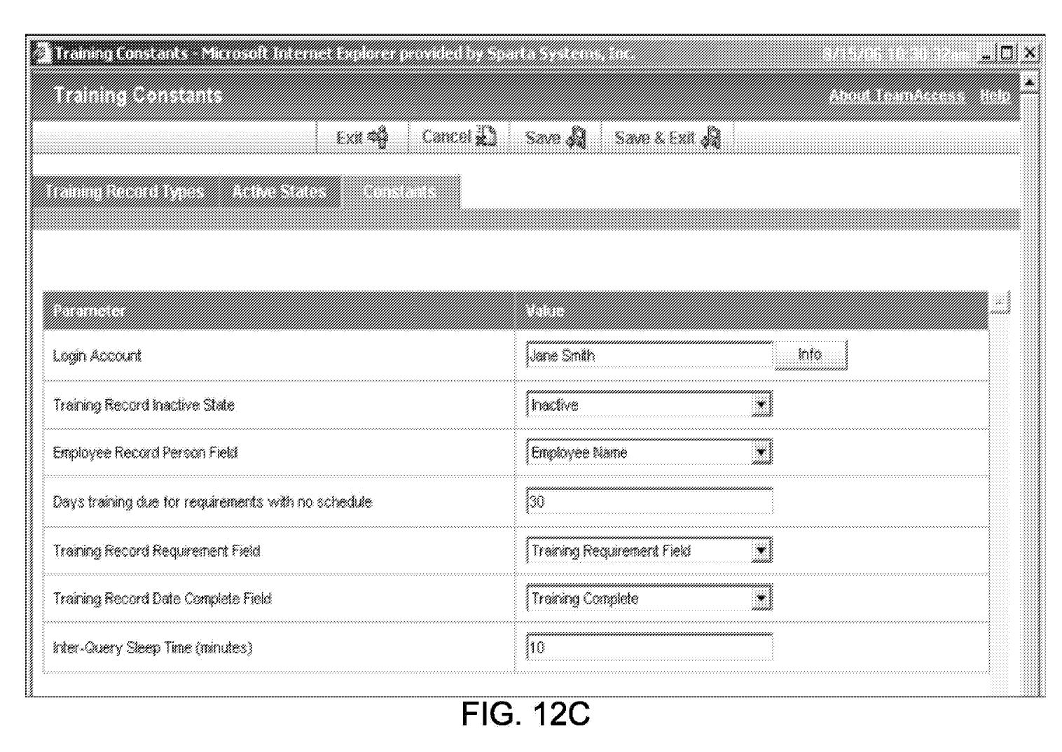

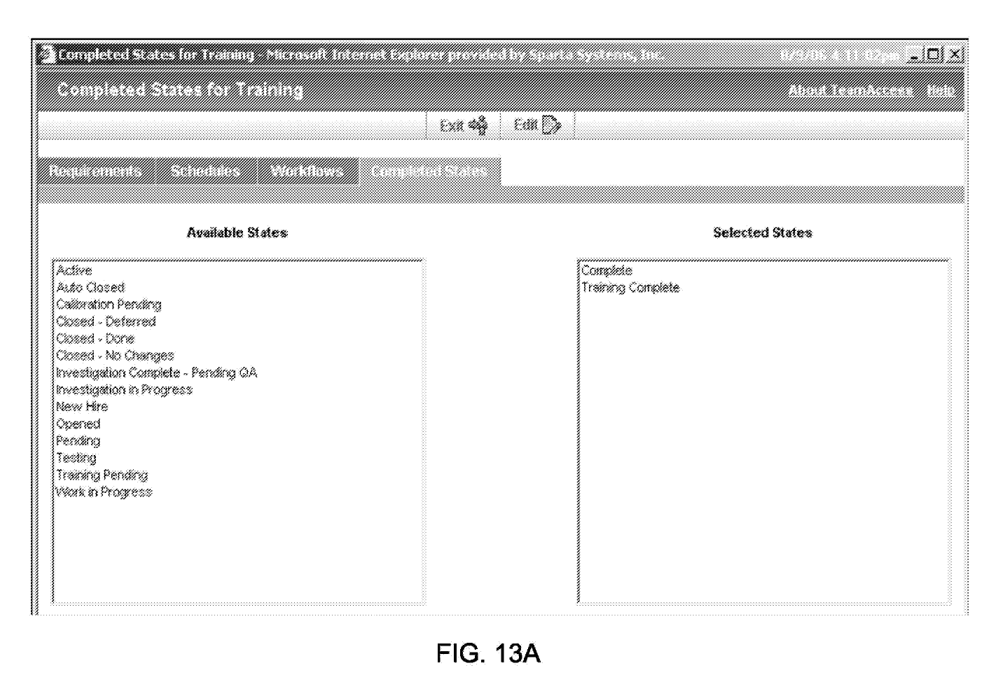

FIGS. 9 through 11 are entity-relationship diagrams which show relationships between the database tables of system 101 which are important in the tracking of training processes. In relational database systems generally, tables are related to each other by values in the tables' records. For example, each record in a first table may have a record identifier field that contains a unique identifier for the record. Each record in a second table may have a record reference field that contains a value which is one of the unique identifiers for the records in the first table. The unique identifier for a given record in the first table may be used in a query to locate records in the second table whose record reference field contains the given record. Similarly, the value of the record reference field may be used in a query to locate the record in the first table whose record identifier field has the value contained in the record reference field in the second table's record. It should be noted here that the relationships between records in tables may be one-to-many, as in the case of the relationship between a given record in the first table and the records in the second table whose record reference field contains the given record's unique identifier, or one-to-one, as is the relationship established by the unique identifier value between a given record in the second table and a record in the first table.

In FIGS. 9 through 11, boxes represented the tables of FIG. 2 are connected by arrows that are labeled with the name of a field whose value is a unique identifier for a record in the table which is the source of the arrow. Values from that field also appear in the records of the table which is the destination of the arrow and relate those records to the record whose unique identifier they contain. The relationship between a record in the table which is the source of the arrow and records in the table which is the destination is generally one-to-many, but is in some cases one-to-one. Some tables in FIG. 2 are not referenced in another table in this manner, and thus do not appear in the entity-relationship diagrams. These tables include the Training_record_type table 207, the Training_emp_active_states table 208, the Training_constants table 210, the Training_completed_states table 212, and the Training_change_control_states table 219. These tables are accessed by the code 109 as needed during execution. The Training_record_type table 207, the Training_emp_active_states table 208, and the Training_change_control_states table 219 are accessed by queries defined in the code 109 during processing. The Training_constants table 210 and the Training_completed states table 212 are accessed by the code 109 at the start of a processing cycle and cached for the duration of the cycle.

As illustrated, a Training Record 206 is created in a project 202, per a Template Record 204, for each training requirement 212 in a curriculum 216 and for each Employee Record 203 in an active state, based on the training workflow 213 and training schedule 215. The creation of the Training Record 206 could have been triggered by a Change Control Record 205 entering a change control state.

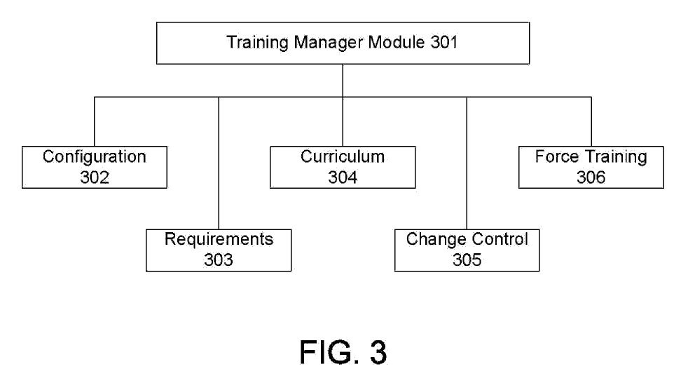

As shown in FIG. 3, the configuration of a training process is accessed through a Training Manager Module 301. The Training Manager Module 301 is a collection of graphical user interfaces (GUIs) through which the user of the system 101 can define PR records for the training process. The module 301 has five areas of interface: Configuration area 302, Requirements area 303, Curriculum area 304, Change Control area 305, and Force Training area 306. The Configuration area 302 allows the configuration of training record types, employee active states, and training constants. The Requirements area 303 allows the configuration of completed states for training, training workflows, training schedules, and training requirements. The Curriculum area 304 allows the configuration of training curriculums, employee title fields, and curriculum mapping. The Change Control area 305 allows the configuration of change control states which trigger training, change control field dependencies, and change control relations. The Force Training area 306 allows a training manager administrator to force retraining on a requirement for a user or group of users.

Once configured, the Process Control Code 109 continually runs the training process and handles the automatic creation of Training Records 206 by evaluating the configuration and schedules training for employees as needed.

Configuration Area

The Configuration area 302 allows the configuration of training record types, employee active states, and training constants.

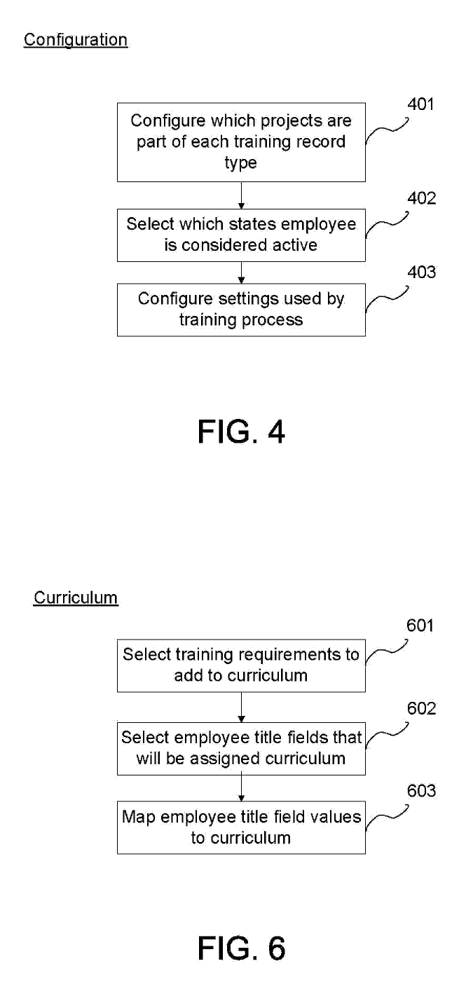

FIG. 4 illustrates the set up of the training process in the Configuration area of the Training Manager module 301. FIGS. 12A-12C show GUIs in the Configuration area 302. Through the GUI of FIG. 12A, the user of the system 101 configures which projects are part of each training record type (step 401). A record is created in the Training_record_type table 207 for each project/training record type combination. In the exemplary embodiment, there are three training record types: employee, template, and change control. The project for the training record type is defined in the configuration of a training workflow, as described further below. Through the GUI of FIG. 12B, the user further selects the states for which an employee is considered active with regard to the training process (step 402). Each state is stored as a record in the Training_emp_active_states table 208. Through the GUI of FIG. 12C, the user further configures constants used by the training process (step 403). Each constant is stored as a record in the Training_constants table 210. Once an employee reaches a state that is active, Training Records 206 will be generated for that employee. If the employee enters a state not designated as active, Training Records 206 that have not been completed will be moved to the inactive states as specified by the configured settings.

Example states include Active, Inactive, New Hire, Training Complete, and Training Pending.

Example constants include:

Login Account: represents the Login Account that will be used when the training process needs to set a Login Account (e.g. when a record is locked or an activity is performed such as the open activity).

Training Record Inactive State: represents the state a record will be moved to when inactivated (i.e. if an Employee Record 203 is moved to a state that is not active and has open Training Records 206, the Training Records 206 will be moved to this state).

Employee Record Person Field: represents the Single Person Data Field that shall signify the person who is the employee. There should be one unique Employee Record 203 created per individual.

Days Training Due for Requirements with no Schedule: represents the number of days later that a rescheduled Training Record 206 is due when this Training Record 206 was opened according to Change Control settings. The configuration of Change Control settings is described further below.

Training Record Requirement Field: represents the Training Requirement field that will exist on the Training Record 206 which will link the Training Record 206 to the training requirements. This field will be automatically populated by the system 101 when Training Records 206 are created and the value populated will be the name of the requirement.

Training Record Date Complete Field: represents the Date field that shall signify the date the Training Record 206 was completed. This field will drive schedules for future training.

Inter-Query Sleep Time: represents how often the training process runs queries.

Requirements Area

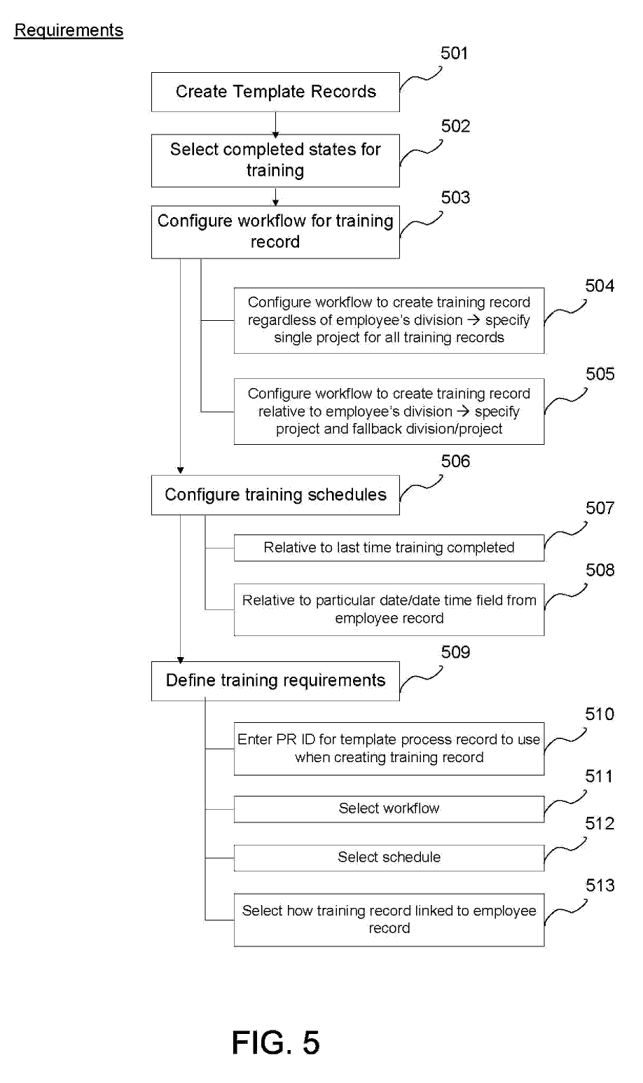

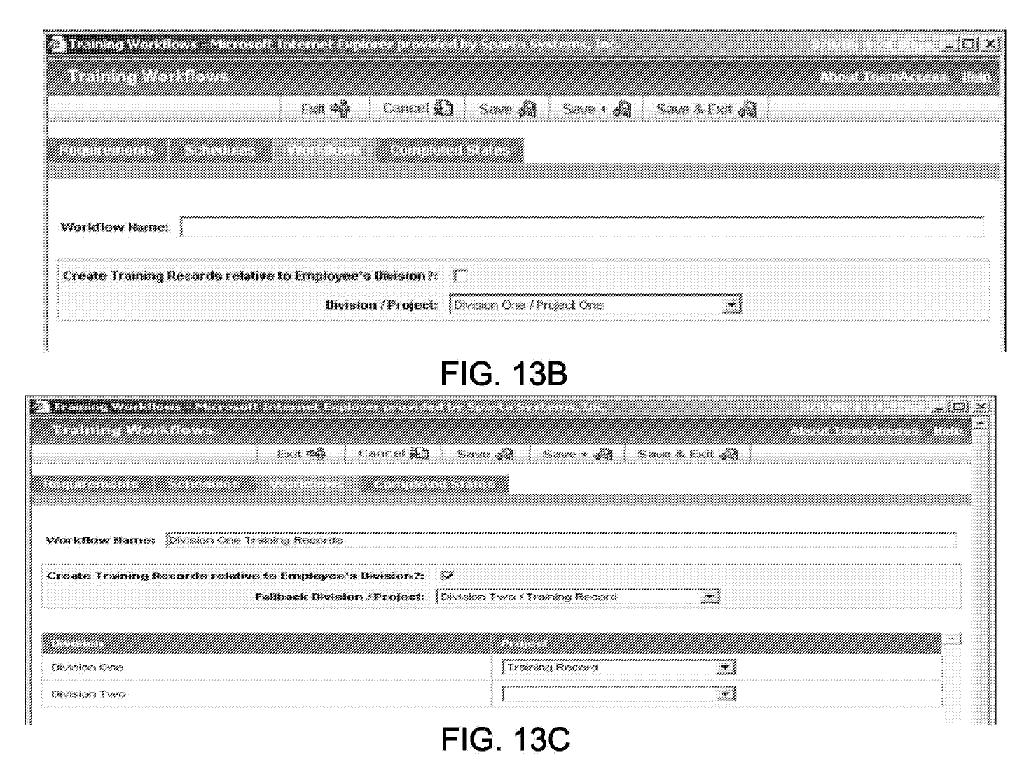

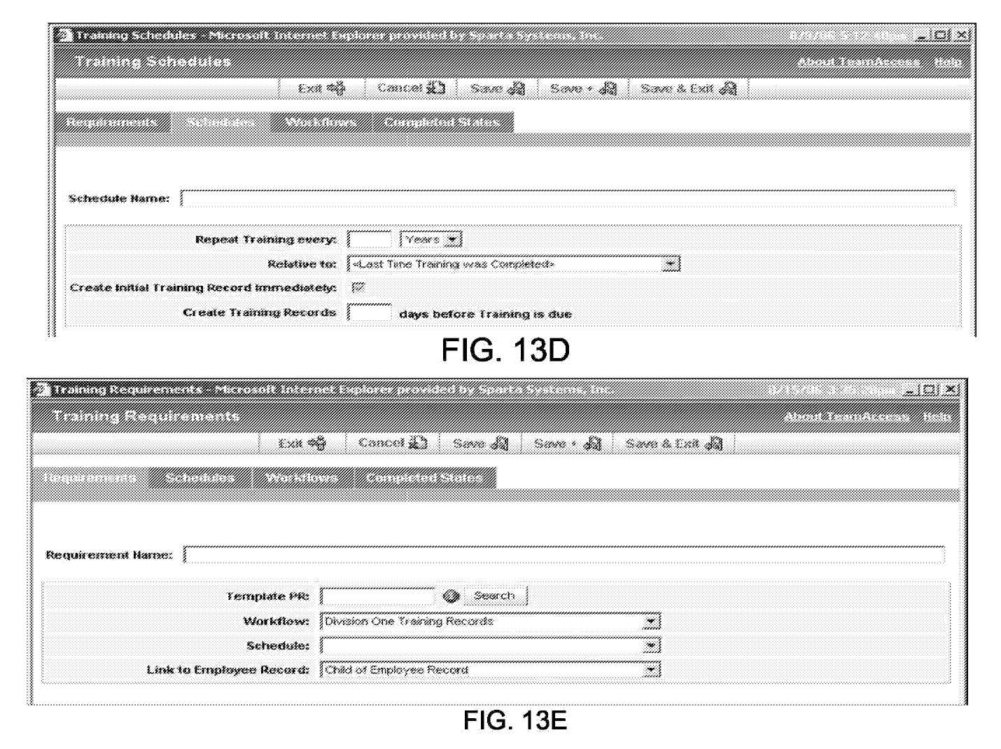

The Requirements area 303 allows the configuration of completed state for training, training workflows, training schedules, and training requirements. FIG. 5 illustrates the set up of the training process in the Requirements area of the Training Manager module 301. FIGS. 13A-13E show the GUIs in the Requirements area 303. The user of the system 101 first creates Template Records 204 that will be used to create Training Records 206 (step 501). To create a Template Record 204, the user creates a PR that will contain all the appropriate fields the user would like to have on the Training Record 206. The Template Records 204 are created in projects that are part of the template record type as configured in the Configuration area 302.

Once the Template Records 204 are created, the user configures the requirements for the training process. Through the GUI of FIG. 13A, the user selects at which states a Training Record 206 is considered complete (step 502). Each state is stored in a record in the Training_completed_states table 212.

Through the GUI of FIG. 13B, the user further configures the workflow for the Training Records 206 (step 503). Each workflow is stored in a record in the Training_workflows table 213. A workflow defines which division and project Training Records 206 will be created in. A training workflow can be configured in one of two ways, creating Training Records regardless of the Employee's Site/Division or creating Training Records relative to an Employee's Site/Division. If the workflow is configured to create Training Records regardless of the Employee's Site/Division, the user specifies a single Division/Project combination within which all Training Records are created based on a training requirement (step 504). The project_id for the project in the Projects table 202 is stored in the Training_workflows record.

If the workflow is configured to create Training Records relative to the Employee's Site/Division, the site is stored in the site specific field. A record for the site is created in the Training_workflow_sites table 214. Through the GUI of FIG. 13C, the user selects the “Create Training Records relative to Employee's Division” option and specifies the project_id for a project for the site/division within which Training Records are created, as well as a fallback division project (step 505). The projects for each division can be configured for any division that contains projects that have a record type of Employee Record. The available projects for the individual divisions and the fallback site projects are those projects that do not have a record type of Employee, Template, or Change Control. A Training Record 206 will be created in the fallback division/project if there is no project specified for the employee's division. If no fallback project is set, then the Training Record 206 will not be created.

Through the GUI of FIG. 13D, the user further configures the training schedules (step 506) for when Training Records 206 should automatically be created. For each training schedule, a record is created in the Training_schedules table 215. When a schedule is used, the Training Record 206 will be created the number of days before the training is due, as specified in the num_days_create_before field. The Training Record 206 due date will be determine based on the values set for the iteration field and the time_interval field. The iteration field is a numeric value that represents when the training should be repeated. The time_interval field represents when a schedule is to be applied. A schedule is created relative to either the last time the training was completed according to the last_time_completed field (step 507), or relative to a particular Date/Date Time field from the Employee Record 203 identified by the date_field_id (step 508). If the create_initial_training_record_immediately field is set to True, then the first Training Record 206 will be created for the user right away regardless of the other schedule settings.

For example, assume a schedule, relative to an employee's hire date, is set to Iterate every year and is set to Create the Initial Training Record Immediately. Assume employee Jane Doe has a hire date of Jan. 1, 2006 and HR Training is created in the system in June 2006 (after Jane's hire date) using this schedule. The initial Training Record 206 for Jane Doe will be created in June 2006. After Jane Doe completes the training according to the initial Training Record 206, the next time Jane Doe will have to complete the training is January 2007 and every year thereafter. Training schedules based on Date or Date/Time fields from Employee Record 203 can only be configured as annual training. The system 101 will only create the Training Records 206 once per employee and per requirement in a given target year, unless Change Control settings trigger retraining.

If Training Records 206 were already created for a current year, the system 101 will not reschedule the training until the next year. For instance, assume a training schedule is based on the employee's Birth Date field. A new requirement is created using this schedule and placed into a curriculum in June. The schedule is set to create the initial Training Record 206 immediately. A person with a birth date in August will already have a Training Record 206 created for his or herself. When August arrives for the current year, training will not be scheduled. However, in August of the following year, training will be scheduled.

Through the GUI of FIG. 13E, the user further defines the training requirements (step 509) to specify the training template, workflow, and schedule to be used and how a Training Record 206 will be linked to the associated Employee Record 203. For each training requirement, a record is created in the Training requirements table 211. The user enters the template_pr_id for the Template Record 204 to use when creating Training Records 206 (step 510), selects the training_workflow_id for the workflow that should be used for this training requirement (step 511), selects the training_schedule_id for the schedule that should be used to determine when Training Records 206 get automatically created for this training requirement (step 512), and selects how the Training Record 206 will be linked to the Employee Record 203 (step 513). The Training Record 206 can be created as a child of the Employee Record 203 by setting the vale of the is_child_of_employee field or by using the ref_record_field_id.

Curriculum Area

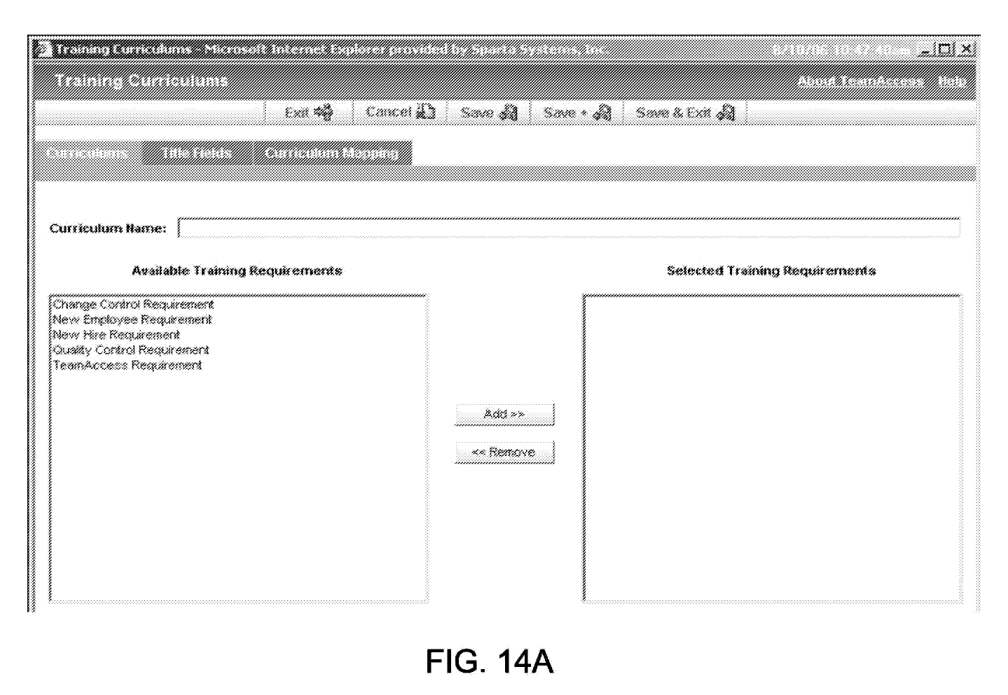

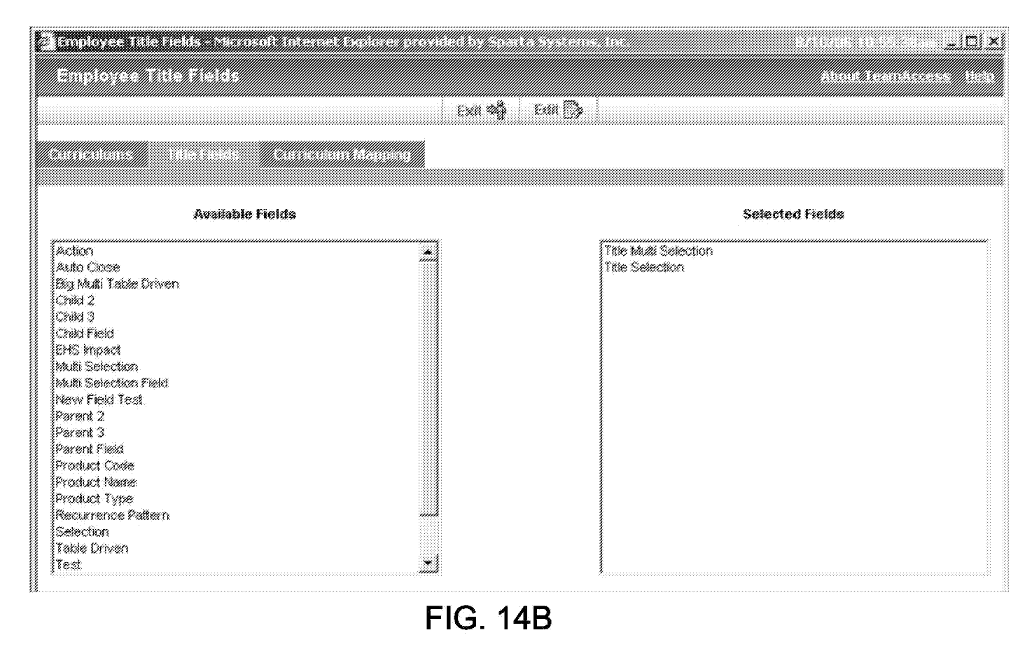

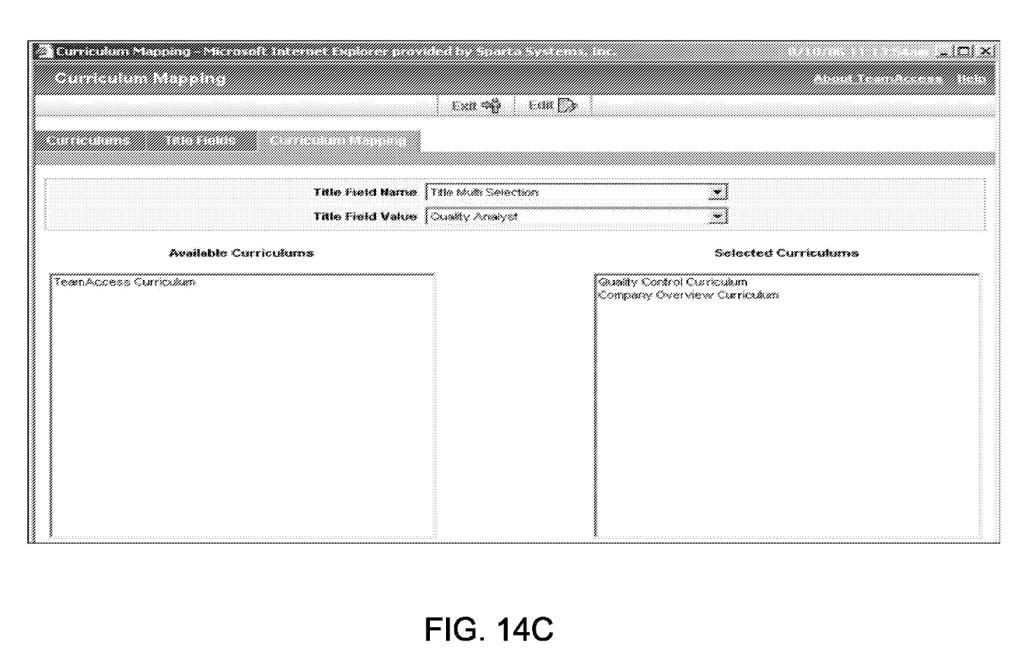

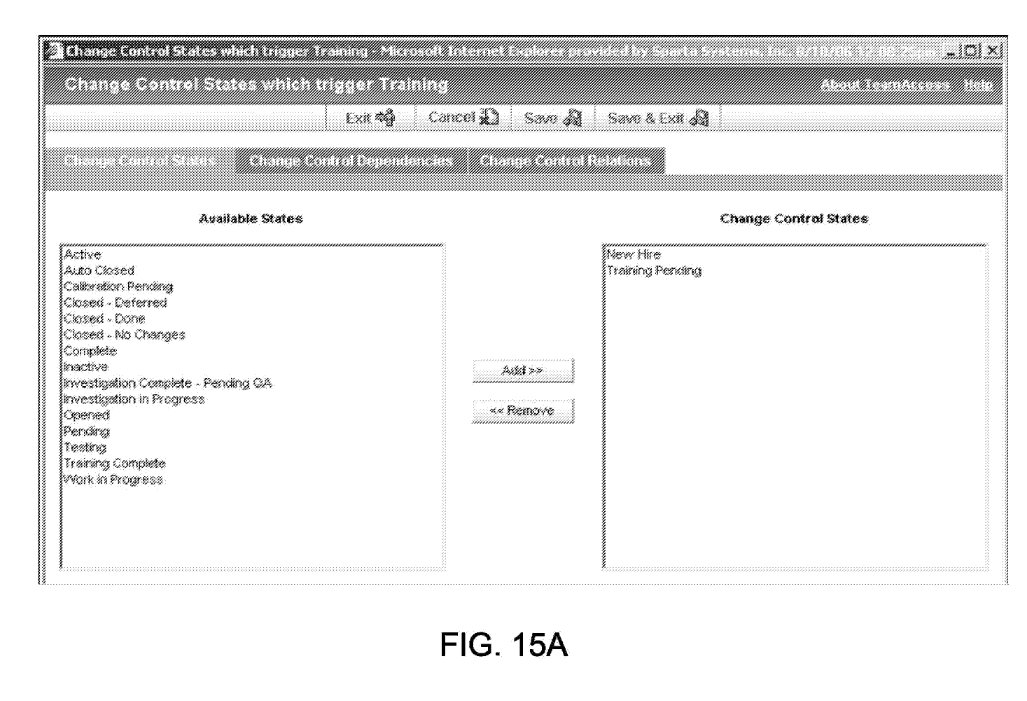

The Curriculum area 304 allows the configuration of training curriculum, employee title fields, and curriculum mapping. Curriculums group together training requirements. FIG. 6 illustrates the set up of a training process in the Curriculum area of the Training Manager module 301. FIGS. 14A-14C show the GUIs in the Curriculum area 304. For each curriculum, a record in the Training_curriculums table 216 is created. Through the GUI of FIG. 14A, the user of the system 101 names the curriculum and selects the training requirements to add to the curriculum (step 601). Each selected training requirement is stored as a record in the Training_curriculum_details table 217, with the training_requirement_id for the training requirement and the training_curriculum_id for the curriculum. Through the GUI of FIG. 14B, the user further selects employee title fields that will be assigned the curriculum (step 602), and through the GUI of FIG. 14C, maps the employee title field values to the curriculum (step 603). Each mapping is stored as a record in the Training_curriculum_rel table 219. The employee title field is specified in the parent_field_id with its value in the parent_n_value_id. The curriculum for the mapping is identified by the training_curriculum_id. If an employee has multiple curriculums that contain the same training requirements, only one instance of the training requirement will be applicable so that the same Training Records 206 do not get created multiple times.

Change Control Area

Change Control is used to track changes in training requirements, and is optional. When a Change Control Record 205 moves into a state that is defined as a change control state, the process control code 109 automatically generates Training Records 206 for employees assigned curriculums that contain the training requirements according to the training schedule. In this manner, changes in the training requirements are automatically propagated to all affected employees. In addition, the Change Control also offers the ability to have parent-child dependencies where the parent field is a selection data field and the child field is a training requirement field. For example, the parent field can be a change in the standard operating procedures, while the child field is a training requirements affected by this change. The Change Control area 305 allows the configuration of change control states which trigger training, change control field dependencies, and change control relations.

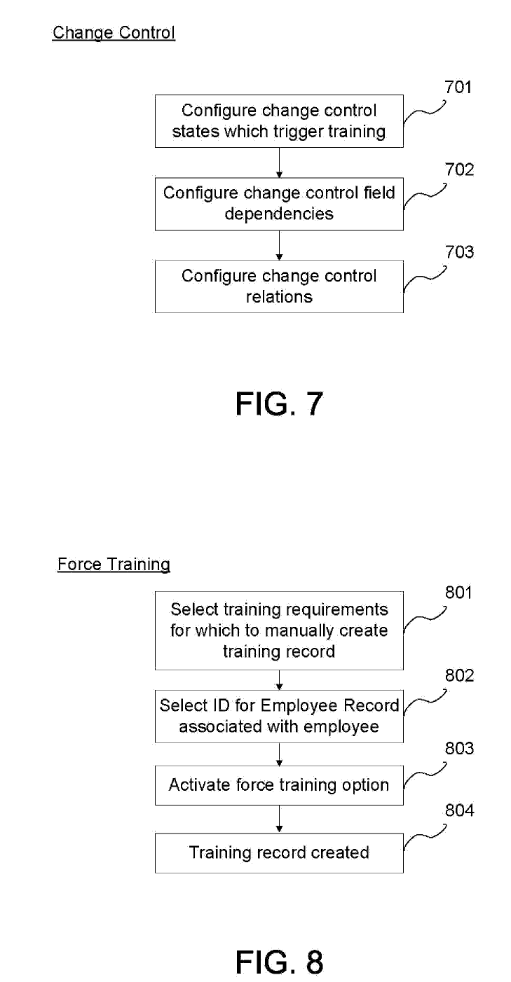

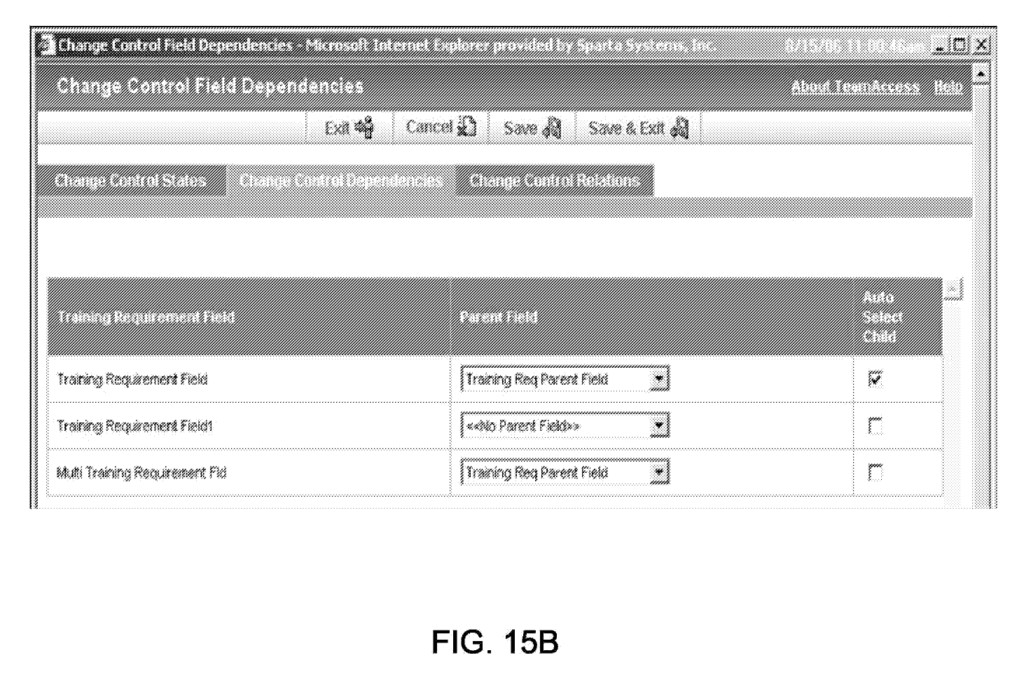

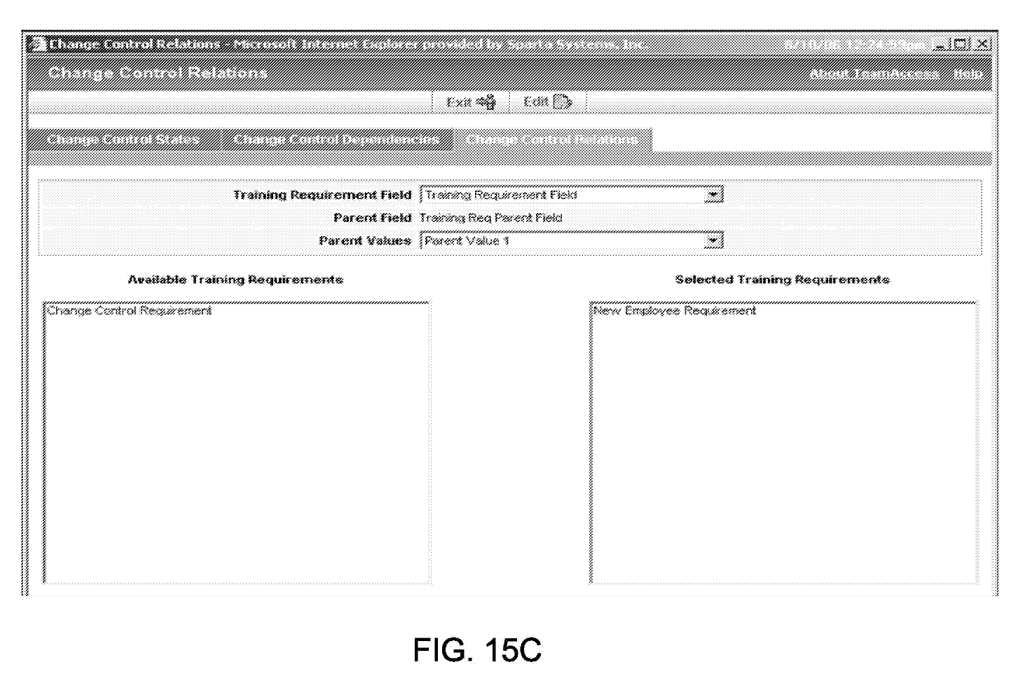

FIG. 7 illustrates the set up in the Change Control area of the Training Manager module 301. FIGS. 15A-15C show the GUIs in the Change Control area 305. Through the GUI of FIG. 15A, the user configures the change control states which trigger training (step 701). Each change control state is stored as a record in the Training_change_cntrl_states table 219. If a Change Control Record 205 configured for a training requirement is moved into a selected state, then a Training Record 206 will be generated.

Through the GUI of FIGS. 15B and 15C, the user further configures the change control field (step 702) and change control relations (step 703) for a training requirement. For each change control mapping to a training requirement a record in the Training_change_cntrl_rel table 220 is created. The user creates parent-child dependencies where the parent_field_id of the parent field is a single selection data field and the child_field_id of the child field is a training requirement. For a single selection data field, only one possible value can be entered. Change control dependencies are not required. If no dependencies are configured, all requirements will be available for selection for the Change Control Records 205.

The user further creates dependent field value relations between the training requirement field value (child_n_value_id) and the training requirement field's parent value (parent_n_value_id). Consequently, when a training requirement field is available on a Change Control Record 205, the available values will depend on the selected value of the parent field. The user can assign which training requirements will be available for selection for the training requirement field when the selected parent field value is selected.

Each time a Training Record 206 is created, a record is created in the Training_history table 221. The record specifies the employee_id of the Employee Record 203 in the PR tables 112 associated with the employee, the training_requirement_id of the training requirement record in the Training_requirements table 211, and the training_record_id of the Training Record 206.

Each time a Training Record 206 is created due to Change Control settings, a record is created in the Training_change_cntrl_history table 223. The record specifies the employee_id of the Employee Record 203 in the PR tables 122 associated with the employee, the training_requirement_id of the training requirement record in the Training_requirements table 211, and the change_control_record_id of the Change Control Record 205 in the PR tables 112.

Force Training Area

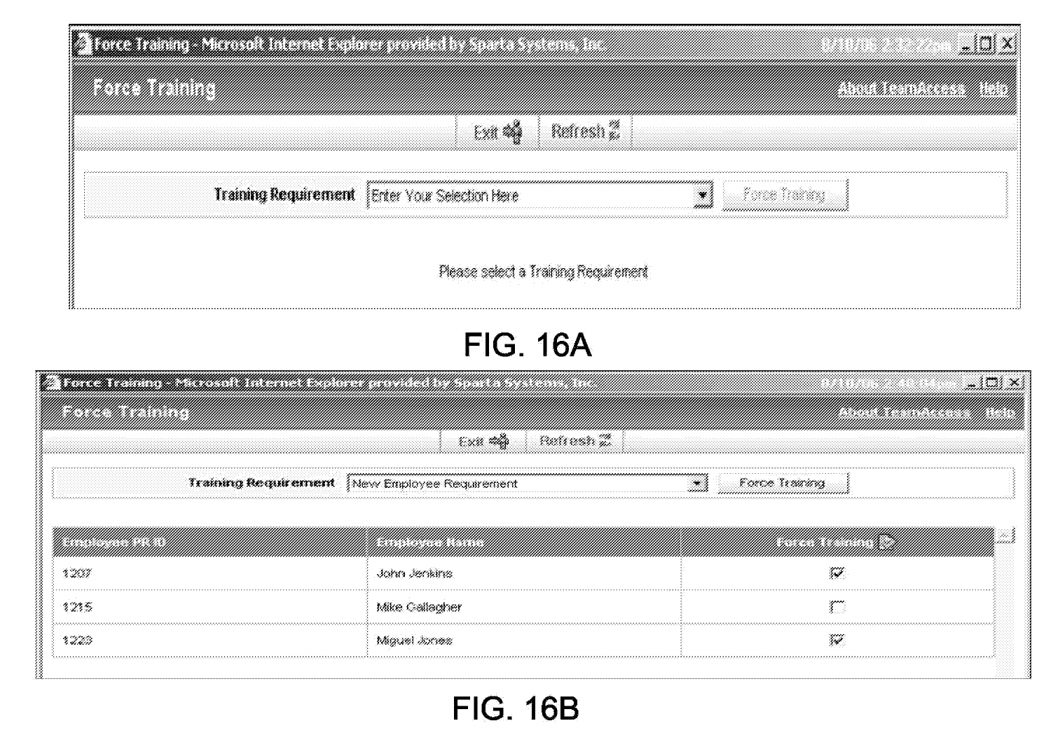

The Force Training area 306 allows a training manager administrator to force retraining on a requirement for a user or group of users. FIG. 8 illustrates the set up of the training process in the Force Training area of the Training Manager module 301. FIGS. 16A-16B show the GUIs in the Force Training area 306. The Force Training area 306 allows users to manually create Training Records 206 for employees. Through the GUI of FIG. 16A, the user selects a Training_requirement_id for a training requirement in the Training_requirements table 211 for which to manually create Training Records 206 (step 801). Through the GUI of FIG. 16B, the user then selects the ID for the Employee Record 203 associated with an employee in the PR tables 112 (step 802), and activates the force training option (step 803) for these Employee Records 203 to make the associated employees eligible to be trained on the selected training requirement. The system 101 then creates the Training Records 206 for the employees (step 804).

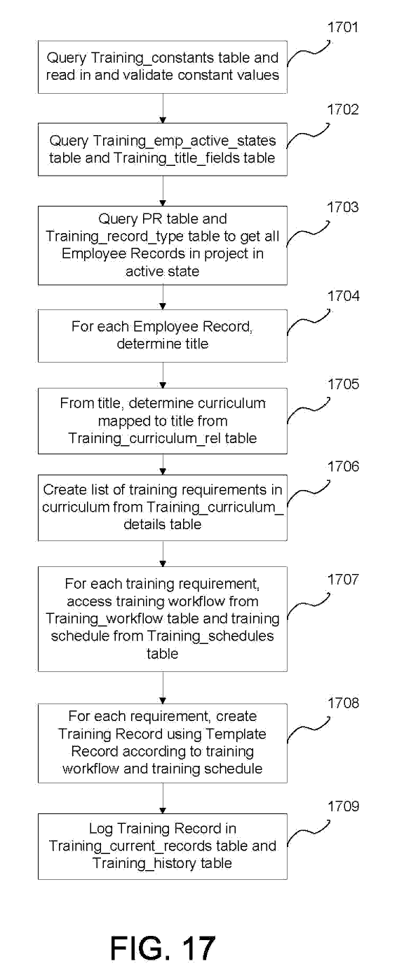

FIG. 17 is a flowchart illustrating the creation of Training Records 206 for employees by the process control code 109. The process control code 109 queries the Training_constants table 210, and reads in and validates the constant values (step 1701). The code 109 queries the Training_emp_active_states table 208 and the Training_title_fields table 209 (step 1702) to obtain the states at which employees are considered active and the title fields from which to determine the employee's job title. The code 109 then queries the PR table 112 and the Training_record_type table 207 to get all the Employee Records 203 in a project in the active state (step 1703).

For each Employee Record 203 returned, the code 109 determines the title of the employee (step 1704). From the title, the code 109 determines the curriculum mapped to the title from the Training_curriculum_rel table 218 (step 1705). A list of training requirements in the curriculum is then created using the Training_curriculum_details table 217 (step 1706). The code 109 queries the Training_curriculum_details table 217 to find all training requirements mapped to the curriculum.

For each training requirement on the list, the code 109 accesses the training workflow from the Training_workflow table 213 and the training schedule from the Training_schedules table 215 (step 1707) (using the training_workflow_id and the training_schedule_id in the training requirements record in the Training_requirements table 211).

For each training requirement, a Training Record 206 is created, using the Template Record 204 associated with the template_pr_id in the training requirements record, according to the training workflow and the training schedule (step 1708). The creation of the Training Record 206 is logged in the Training_current_records table 222 and the Training_history table 221 (step 1709).

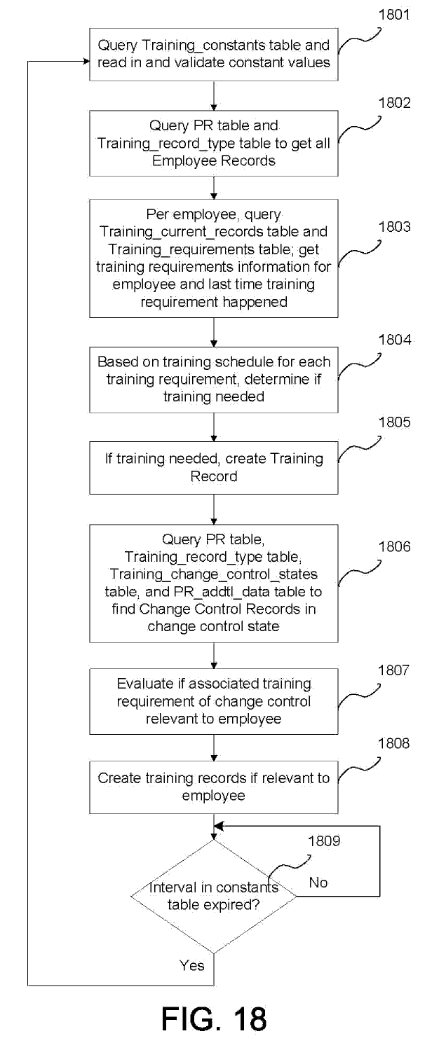

FIG. 18 is a flowchart illustrating the tracking of Training Records 206 for employees by the process control code 109. The code 109 runs periodically according to an Inter Query Sleep Time constant from the Training_constants table 210. Each time the code 109 runs, it queries the Training_constants table 210 and reads in and validates the constant values (step 1801). The code 109 queries the PR table 112 and the Training_record_type table 207 to get all Employee Records 203 (step 1802). For each employee represented by an Employee Record 203, the code 109 queries the Training_current_records table 222 for training current records containing the Employee Record's employee_id. The code 109 also queries the Training_requirements table 211 to get the training requirement records associated with the training_requirements_id's in the training current records (step 1803). The training current records further contain the last time the training was completed or cancelled. In this manner, training requirement information for the employee and the last time the training requirement happened are determined.

Each of the training requirement records obtained by the code 109 contains identifiers for the training workflow and the training schedule for the training requirement. Through these identifiers, the process control code 109 obtains the training workflow record from the Training_workflow table 213 and the training schedule from the Training_schedules table 215. The code 109 then determines if training is needed for the employee (step 1804) based on the training schedule for the training requirement. If training is needed, a Training Record 206 is created for the training requirement for the employee (step 1805). The Training Record 206 is created in the same manner as described above with steps 1708 and 1709.

For each employee, the code 109 further queries the PR table 112, the Training_record_type table 207, the Training_change_cntrl_states table 219, and the PR_addtl_data table 224 to find Change Control Records 205 that have moved into a change control state (step 1806). The code 109 then evaluates if the training requirement associated with each Change Control Record 205 is relevant to the employee (step 1807). In this evaluation, the code 109 queries the Training_current_records table 222 for records matching both the employee_id of the Employee Record 203 associated with the employee and the training_requirement_id for the training requirements associated with the change control. For each matching training requirement, a new Training Record 206 is created for the employee, according to the training workflow and training schedule associated with the training requirement (step 1808). The creation of the Training Record 206 is logged in the Training_current_records table 222 and the Training_history table 221. The code 109 repeats steps 1801 through 1808 according to the Inter Query Sleep Time constant (step 1809).

Conclusion

The foregoing Detailed Description has disclosed to those skilled in the relevant arts how to make and use a process control system that automatically provides as much monitoring as is desirable for the training processes being controlled and disclosed to those skilled in the relevant arts the best mode presently known by the inventors for implementing their process control system. The information needed to automatically create Training Records to implement the training process is all contained in tables in a database system. The fact that the information is in a database tables makes the process control system easily and safely configurable and extendible.

It will be immediately apparent to those skilled in the relevant arts that there are many other ways of implementing the invention. In particular, there are many ways in which the information needed to implement the training process can be represented in the database system. For all of the foregoing reasons, the Detailed Description is to be regarded as being in all respects exemplary and not restrictive, and the breadth of the invention disclosed herein is to be determined not from the Detailed Description, but rather from the claims as interpreted with the full breadth permitted by the patent laws.

What is claimed is:

1. A process control system, comprising:
a server that has access to a database system and executes program code for the process control system;
a process record table in the database system that contains one or more training process records, the training process records comprising:
employee records from which a person's eligibility for training requirements is determinable,
template records for defining fields to be copied to training records, and
the training records which relate persons eligible for training to the training requirements;
a training requirements table in the database system that contains one or more training requirement records associated with the training requirements, each training requirement record specifying one of the template records and a training schedule; and
a portion of the program code which, when executed, automatically creates, for each person eligible for the training requirement, the training record for each training requirement according to the template record and the training schedule specified in the associated training requirement record.

2. The system of claim 1, wherein the person is eligible for the training requirement if the employee record associated with the person specifies a job title determined to be eligible for the training requirement and specifies an employee active state.

3. The system of claim 1, wherein each training requirement record further specifies a training workflow, the training workflow specifying a project in which the training record is to be created in.

4. The system of claim 1, wherein the training schedule specifies that the training record is to be created a number of days before the training requirement is due.

5. The system of claim 1, wherein the training schedule specifies that the training records is to be created at a time relative to either a last time a training was completed or a time relative to a particular date or time.

6. The system of claim 1, wherein the training requirements are grouped into curriculums, wherein each curriculum is mapped to an employee job title.

7. The system of claim 6, wherein when the portion of the program code executes, a list of the training requirements in the curriculum is created, and the training record is created for each training requirement for each person with the employee job title, according to the template record and the training schedule specified in the associated training requirement record.

8. The system of claim 1, further comprising a training history table in the database system for storing a row for each eligible person per training requirement per training record.

9. The system of claim 8, further comprising a training current records table in the database system with a subset of records of the training history table.

10. The system of claim 1, further comprising a training constants table in the database system for storing global settings for the training process.

11. The system of claim 1, wherein the training process records further comprise change control records for tracking changes to the training requirements.

12. The system of claim 11, wherein when one of the change control records moves into a change control state, the training record is created for each training requirement associated with the change control record for each eligible person according to the template record.

13. The system of claim 1, further comprising a computer readable medium for storing the program code.

14. A method for defining training requirements for employee training in a process control system, comprising:
creating template records in a database system for defining fields to be copied to training records, the training records relating persons eligible for training to training requirements, a person's eligibility for the training requirements being determinable through employee records in the database system;
configuring training schedules for the training requirements; and
associating each training requirement with one of the template records and one of the training schedules,
wherein when a portion of a program code for the process control system executes, the training records are automatically created for each training requirement for each person eligible for the training requirement, according to the template record and the training schedule associated with the training requirement.

15. The method of claim 14, further comprising:
configuring training workflows for the training requirements, the training workflows specifying projects in which the training records are to be created in.

16. The method of claim 14, wherein the training requirements are grouped into curriculums, wherein each curriculum is mapped to an employee job title in the employee records.

17. The method of claim 16, wherein when the portion of the program code executes, a list of the training requirements in the curriculum is created, and the training record is created for each training requirement for each person with the employee job title, according to the template record and the training schedule associated with the training requirement.

18. A method for tracking employee training in a process control system, comprising:
obtaining constants values for global settings for a training process from a training constants table in a database system;
obtaining employee active states from a training employee active states table and job title fields from a training title field table in the database system, the employee active states indicating the states in which a person is considered active for training, the job title fields for determining a person's eligibility for training requirements, the job title fields residing in employee records in a database system;
for each employee record in the employee active state, determining if a job title field value in the employee record indicates that the person is eligible for the training requirements;
if the person is eligible for the training requirements, determining a curriculum mapped to the job title field;
creating a list of training requirements in the curriculum;
for each training requirement on the list, obtaining from a process record table in the database system a template record for defining fields to be copied to training records and a training schedule from a training schedule table in the database system, the template record and the training schedule associated with the training requirement; and
for each training requirement, creating the training record using the template record according to the training schedule.

19. The method of claim 18, for each training requirement on the list, further obtaining a training workflow specifying a project in which the training record is to be created in.

20. The method of claim 18, further comprising:
logging the creation of the training record in a training current records table in the database system.

21. The method of claim 20, further comprising:
for each eligible person, obtaining records from the training current records table that includes an employee identifier for the eligible person, the obtained training current records each including an identifier for a training record, an identifier for a training requirement associated with the training record, and a last time the training requirement happened;
for each training requirement identified in the obtained training current records, determining if training is needed based on a training schedule associated with the training requirement; and
if training is needed, creating a training record for the training requirement for the eligible person.

22. A method for tracking changes to employee training in a process control system, comprising:
obtaining change control states from a change control states table in a database system;
querying a process records table in the database system to find change control records in the change control states, each change control record including a training requirement identifier;
for each employee and each change control record, querying a training current records table in the database system for training current records that match an identifier for the employee and the training requirement identifier in the change control record; and
creating for the employee a training record for a training requirement associated with the training requirement identifier in the change control record.

23. The method of claim 22, wherein the training record is created in a project specified by a training work flow associated with the training requirement.

24. The method of claim 22, wherein the creating comprises:
obtaining from a process records table in the database system a template record for defining fields to be copied to training records, the template record associated with the training requirement; and
creating the training record using the template record.

25. A process control system having a server that has access to a database system and executes program code for the process control system, and a process record table in the database system that contains one or more process records, wherein the improvement comprises:
automatically creating training records in the process record table by a portion of the program code according to training schedules, each training record relating a person eligible for training to a training requirement and a training schedule associated with the training requirement.
